(19) United States
(12) Patent Application Publication
(10) Pub. No.: US 2001/0013063 A1
(43) Pub. Date: Aug. 9, 2001

(54) System and method for applying printer-specific formatting

(76) Inventors: David M. Hall, Camas, WA (US); Michael D. Whitmarsh, Vancouver, WA (US); Jeff M. Anderson, Camas, WA (US)

Correspondence Address: HEWLETT-PACKARD COMPANY, Intellectual Property Administration, P.O. Box 272400, Fort Collins, CO, 80527-2400, US

(21) Appl. No.: 09/754,502

(22) Filed: Jan. 3, 2001

Related U.S. Application Data
(63) Continuation-in-part of application No. 09/499,876, filed on Feb. 8, 2000.

(51) Int. Cl. G06F 15/16

(52) U.S. Cl. 709/219

(57) ABSTRACT

The invention provides a system and method of printer-specific formatting of an application output in a server system wherein the method involves polling a computer system for print information regarding a printer associated with the computer system, retrieving formatting information corresponding to the print information from a data structure, and applying the formatting information to the application output to produce a printer-specific print job for printing on the printer.

### CROSS REFERENCE TO RELATED APPLICATIONS

This application is a continuation-in-part of U.S. patent application Ser. No. 09/499,876, filed Feb. 8, 2000, of Stephen D. Dentel et al. for a SYSTEM AND METHOD FOR REMOTELY RETRIEVING INFORMATION FROM A COMPUTER PROCESSING SYSTEM, the disclosure of which is hereby incorporated by reference.

### TECHNICAL FIELD

The present invention relates generally to communicating information over a computer network, and more particularly, to a system and method for applying printer-specific formatting to a print job which is to be printed on various printers.

### BACKGROUND ART

The rising popularity of the Internet in recent years has been a strong incentive for people to own a personal computer. In addition, as moderately-priced computers have become available, the personal computer has been transformed into a recreational and entertainment device rather than just a tool for the business and scientific community. As the market for computers has changed, hardware manufacturers and software developers have sought continuously to create products that are easier to use and require less technical skills. Ideally, the various hardware and software components of a computer system should work and communicate together automatically, without requiring a user to act as an intermediary.

Typically, it is the role of a computer operating system to act as the intermediary between the various hardware and software components of a computer. The operating system maintains information regarding the identity and status of the various components of the computer, and communicates with the components to receive and transmit such information as needed. However, concerns over data security preclude allowing external computers and components to directly access the information maintained by the operating system. As a result, it is sometimes necessary for the user to become involved when information regarding the user's computer must be communicated to an external site.

For example, a computer user may need to apply particular formatting principals during generation of a print job based on the specific printer used. Different printers, it will be appreciated, may have different formatting parameters, and thus may place printed output in different locations on a printed page. Formatting parameters such as printable area, margin size, color printing capabilities and duplex printing capabilities all can impact presentation of a print job. While such parameters may be available for generating print jobs within the computer system, formatting parameters typically are not available for use in remote generation of a print job, as in a server-side software application. Accordingly, users may be required to specifically identify the printer model used when printing a remotely generated print job. This can be frustrating to users with little technical training or skills, and may prevent or delay a print operation. Thus, it would be preferable if the information required in these situations could automatically be determined and communicated to the external site without the user's involvement.

### SUMMARY OF THE INVENTION

The invention provides a system and method of printer-specific formatting of an application output in a server system wherein the method involves accessing an interrogator subroutine in a computer system to poll the computer system for print information regarding a printer associated with the computer system, retrieving formatting information corresponding to the polled print information from a data structure, and applying the formatting information to the application output to produce a printer-specific print job for printing on the printer.

The method typically employs an Internet communications link to communicate with the computer system, and more particularly, with an interrogator subroutine resident on the computer system. As indicated, the interrogator subroutine retrieves print information about the associated printer in response to a request from the server system, the print information typically taking the form of the printer's manufacturer and model number. This information is then communicated to the server system, and used by a format engine to retrieve printer-specific format information from the data structure. The format engine then applies the retrieved formatting parameters to an output of a server-side software application so as to produce a printer-specific print job for printing on the printer.

Accordingly, the invention also concerns a printer-specific formatting system for formatting an output of a software application where the formatting system includes a computer system with a printer and an interrogator subroutine for identifying the printer, and a server system with a format engine and data structure configured to relate printers to format parameters associated with such printers. The format engine accesses the interrogator subroutine to determine the printer identity, and retrieves format parameters corresponding to the printer identity from the data structure. The format engine also applies such format parameters to the output of the software application to produce a printer-specific print job, the printer-specific print job being communicated to the computer system for printing on the identified printer.

### BRIEF DESCRIPTION OF THE DRAWINGS

FIG. 1 is a schematic illustration of a formatting system for use in generating a printer-specific print job in accordance with the present invention.

FIG. 2 is a flow diagram demonstrating a method for printer-specific formatting of an output.

### DETAILED DESCRIPTION OF AN EXEMPLARY EMBODIMENT AND BEST MODE FOR CARRYING OUT THE INVENTION

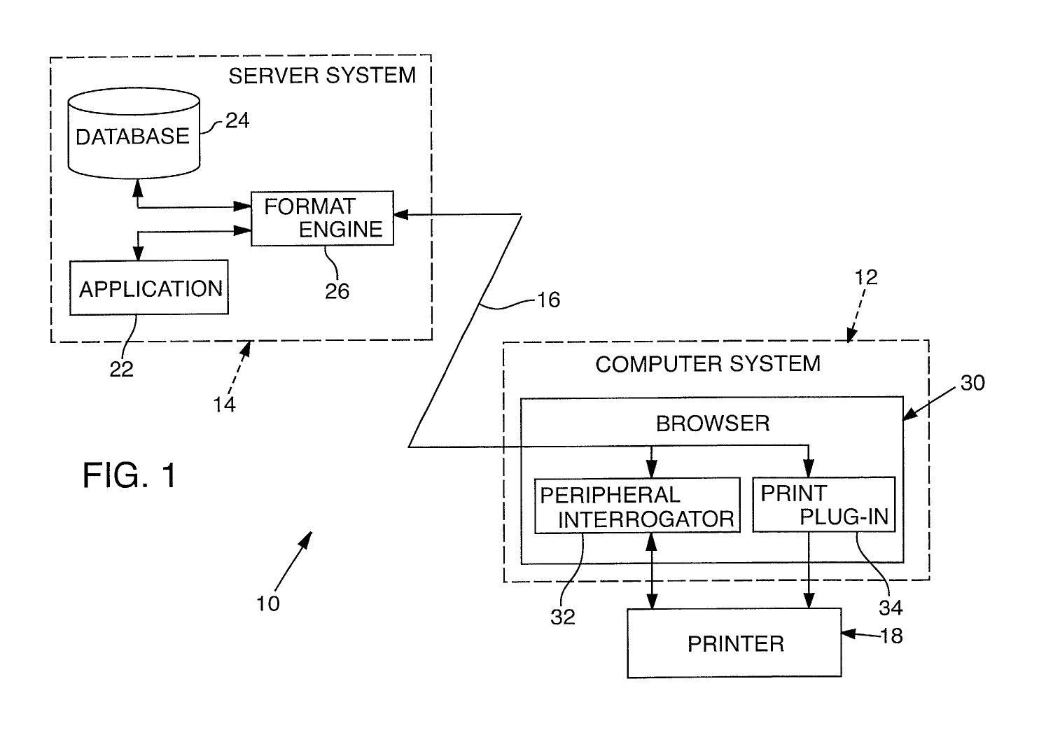

A formatting system for remotely retrieving printer information from a computer system is indicated generally at 10 in FIG. 1. As shown, system 10 includes a computer system 12 in communication with a server system 14 via a communications link 16. Computer system 12, it will be appreciated, employs a processor with an operating system configured to execute computer software instructions. Server system 14 employs one or more computer servers of the type known to those of skill in the art. Server system 14 may be remote from computer system 12, and thus connected to the computer system via a remote communications link such as the Internet.

Computer system 12 (computer 12) may be a network computer, a personal computer, a set-top box, a personal digital assistant, or any other similar device having a computer processor. Correspondingly, the computer processor may be any suitable processor such as a PENTIUM processor, etc. Computer 12 may be operably associated with one or more peripheral components, one such peripheral component taking the form of a printer such as that shown at 18.

Server system 14 (server 14) may include any one or more of a variety of suitable computer servers such as, for example, an Internet application server of the type known to those of skill in the art. As indicated, server system 14 typically includes a software application 22 capable of producing an output in the form of an output expression template for printing on a printer of the remote computer. The server system also typically includes a data structure or database 24, which stores format information particular to various printers which may be used by computer 12. The database, it will be appreciated, may have any suitable database configuration, but typically is organized based on printer model, each model having particular format parameters.

A format engine 26 is configured to receive an output from the software application, and to access database 24 to retrieve format information from the database. Such format information typically includes printer-specific format parameters, such as printable area, margin size, color printing capabilities and duplex printing capabilities. These format parameters serve in formatting the output for printing on printer 18.

It will be appreciated, for example, that different printer models may have different maximum printable areas, and thus may require scaling of an output to achieve consistent printing of a print job across such different printer models. Similarly, where different printer models have different margin minimums (top, bottom or sides), it may be necessary to scale or offset an output in order to meet such margin minimums.

Those skilled in the art will appreciate that application 22, database 24 and format engine 26 may all reside on a single computer or be distributed across a plurality of interconnected computers. Furthermore, while server system 14 is illustrated as communicating with a single computer, it is within the scope of the invention for server system 14 to communicate with a plurality of distributed computers via link 16.

Communications link 16 may be any one device or combination of devices and/or media for transmitting computer information between remote locations including a local area network (LAN), wide area network (WAN), intranet, extranet, wireless broadcast, etc. Typically, link 16 may be an Internet communications system (hereinafter Internet), and computer system 12 and server system 14 are configured to transmit information via the Internet using standard Internet communications protocols such as the TCP/IP (Transmission Control Protocol/Internet Protocol) protocol suite. In an exemplary embodiment of the invention, server system 14 communicates with computer 12 using HTTP (Hyper-Text Transport Protocol) commands to transmit “web pages” formatted as HTML (Hyper-Text Markup Language) files. Alternatively, other communication protocols and formats may be used.

As shown in FIG. 1, computer 12 includes software, such as an Internet navigation interface or browser 30, which is executable by the processor to receive the web pages and display them to a user on a printer, or via some other output device. Browser 30 may be any suitable browser such as MICROSOFT INTERNET EXPLORER, NETSCAPE NAVIGATOR, etc. Browser 30 also is adapted to communicate with server 14 by using HTTP commands or other suitable protocols to request specific web pages, and transmit information, etc., as directed by the user via a keyboard, mouse, etc.

In addition to communicating information from a user, computer 12 also is adapted to communicate information from one or more peripheral components (e.g. printer 18) to the server. Computer 12 thus includes an interrogator subroutine 32 (hereinafter interrogator 32), which is executable by the processor to poll the operating system or one or more peripheral components for selected information in response to a request from server 14. The component information is then communicated to the server 14 via communications link 16.

It will be appreciated that interrogator 32 may be implemented in a variety of ways within the scope of the invention. In the exemplary embodiment, the interrogator is configured as a software subroutine, or “plugin,” to Internet browser 30. Interrogator 32 typically is stored in the browser's plug-in directory on computer 12, and loaded into the processor along with the browser. The interrogator is accessible by server 14 through predetermined commands or function calls defined by the application programming interface (API) of the interrogator.

Server 14 responds to a request from the browser for a print job by embedding the appropriate function calls to interrogator 32 in an HTTP transmission to the browser. When the transmission is received by the browser, the interrogator is called to poll printer 18 for print information, namely the printer manufacturer and model number. The print information is then communicated back to the server in an HTTP transmission from the browser via link 16. Thereafter, the print information may be used in accessing format information stored in database 24. This formatting information, in turn, may be used by format engine 26 to format an output of application 22 in accordance with the format parameters of printer 18. The resulting print job is communicated to computer 12 via communications link 16. The print job then is passed to printer 18 via print plug-in 34, and printed.

Interrogator 32 may be installed in computer 12 at the same time the browser is installed. Alternatively, the interrogator may be installed subsequent to the browser, either from a physical storage medium adapted to be read by computer 12 such as a CD-ROM or floppy disk, or downloaded via communications link 16 from a server such as server 14.

In response to a request from server 14, interrogator 28 may be configured to selectively determine various pieces of format information from printer 18. For example, the interrogator may be configured to determine the type, manufacturer and/or model of the printer. The interrogator also may be configured to determine the size of the printable area, the minimum margins, whether the printer is a multi-color printer or a single-color (i.e. black) printer, and/or whether the printer is capable of duplex printing.

Additionally, the interrogator may be configured to determine the operating configuration of the computer, such as which printer is the default printer, and whether the printer is connected to the computer locally or via a network. As another example, the interrogator may be configured to determine the status of the printer such as whether the printer is low on ink, and/or whether the printer is currently configured for color printing.

It will be appreciated by those skilled in the art that interrogator 32 may be adapted to determine print information in a variety of ways. Typically, an operating system is configured to provide information regarding a variety of components through standard function calls. For example, the MICROSOFT WINDOWS 95 operating system provides an “EnumPrinters” function that is adapted to provide a list of all printer components. Thus, when server 14 calls the appropriate function of interrogator 32 to determine the printers connected to computer 12, the interrogator may in turn poll the operating system to determine the information by calling the “EnumPrinters” function. The operating system typically is configured to determine such information by communicating with the printer via software drivers (not shown) installed on the computer and executable by the computer processor.

Interrogator 32 may also be configured to determine print information by polling the printer directly rather than through the operating system. For example, interrogator 32 may be configured to poll the computer system (either the computer operating system or the printer itself) for information typically supported by printer connection standards such as IEEE 1284. The interrogator may access the printer via the printer driver, or may include a separate driver to access the printer independent of the printer driver.

It will be appreciated that while interrogator 32 is described as being capable of polling the printer directly, the interrogator nevertheless will typically communicate with the printer through the operating system. Furthermore, the information retrieved by the interrogator typically is supplied by the operating system based on information received from the printer. Information polled from the operating system may include the manufacturer and model number of the printer, the supported command set, the communication ports, etc. In addition, some printers may be configured to provide information relating to the amount/status of ink, toner, paper or other consumables, or the presence of particular features such as an automatic duplexer.

As discussed above, once interrogator 32 determines the print information requested by server 14, the print information is passed to browser 30 for communication to the server. In the exemplary embodiment of the invention, where communications link 16 is the Internet, the browser transmits the print information to the server using the server's Internet address, or URL (uniform resource locator), which the server provides when requesting the print information.

Typically, database 24 includes a list of known printer models along with format parameters particular to each printer model. For example, the database may include: 1) the size of the printer's printable area; 2) the printer's minimum margins; 3) whether the printer is a multi-color printer or a single-color (i.e. black) printer; and/or 4) whether the printer is capable of duplex printing. These parameters, it will be appreciated, are useful in determining scaling and/or offset characteristics for formatting an output to produce a printer-specific print job.

Format engine 26 is configured to access the database to find the identified printer model(s), and the format information associated with such printer model. The format engine also is configured to apply the format information to an output from application 22, and to transmit a corresponding properly-formatted print job to computer 12 for printing on printer 18.

Where multiple printers are available, the computer may present a user-selectable list of printers identified by interrogator 32. A user thus may select a printer model, and thereby request that a print job be formatted in accordance with the format parameters of the identified printer model.

The capability of server 14 to transmit print jobs formatted for the particular printer used can provide substantial convenience to the user. For example, in the illustration above the user is able to confidently order a print job without having to determine whether there will be any discontinuity in the output due to the format parameters of the printer on which the print job is to be printed. Additionally, since the retrieval of the print information is carried out automatically when the user requests a print job, the user can print more quickly than if it were necessary for the user to provide the print information to the server.

In one example demonstrating use of the present system, it is noted that users often desire to print a print job (e.g., a greeting card, etc.) received from server 14. In existing systems, server 14 must send prompts or dialog boxes for display to the user to determine the printer type or specific features of the printer such as the printable area, minimum margin sizes, print-quality capability, whether the printer supports duplex or large format printing, whether the printer is a top-load or front-load printer, and/or whether the printer is capable of printing in color. The user is therefore required to determine the necessary information and transmit it to server 14.

Since many users do not readily possess the necessary information, they may be unable to print the print job correctly. However, where interrogator 32 is configured to poll the operating system, or the printer, to identify the printer, the server may retrieve the necessary format information automatically without involving the user. The retrieved format information thus may be used in dynamically adjusting the format (e.g., scaling, offset, etc.) to create a more predictable print product where the printer model may vary from print job to print job.

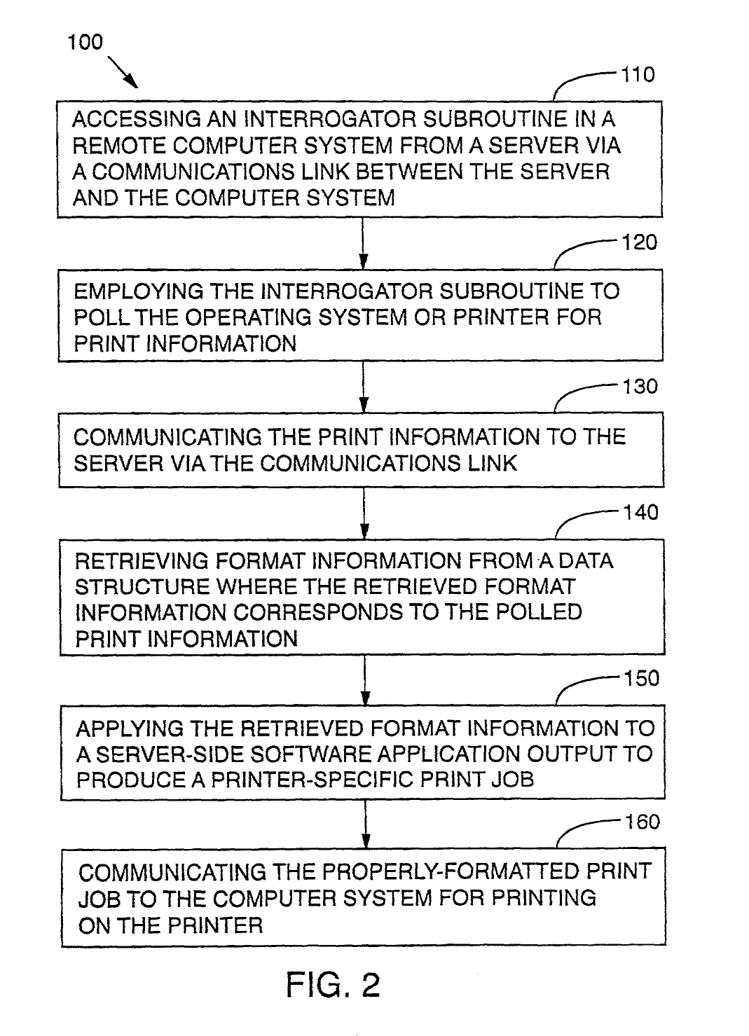

As described above, the invention provides a system for allowing a server system to retrieve selected printer information from a remote computer system via a communications link for use in properly formatting an output of a server-side software application. The invention also concerns a method for retrieving print information from a computer system and formatting an output of a server-side software application, as indicated generally at 100 in FIG. 2. The method is implemented by software running on server 14 and/or computer 12.

The method includes, at step 110, accessing an interrogator subroutine in a remote computer system from the server via the communications link between the server and the computer system. In response to such access from the server, the interrogator subroutine polls the operating system or printer for print information, as indicated at step 120, and communicates the print information to the server as indicated at step 130. Method 100 also includes, at step 140, retrieving format information from a data structure where the retrieved format information corresponds to the polled print information, and at step 150, applying the retrieved format information to a server-side software application output to produce a printer specific print job. At step 160, the properly-formatted print job is communicated to the computer system for printing on the printer.

While the invention has been disclosed in its preferred form, the specific embodiments thereof as disclosed and illustrated herein are not to be considered in a limiting sense as numerous variations are possible. Applicants regard the subject matter of their invention to include all novel and non5 obvious combinations and subcombinations of the various elements, features, functions and/or properties disclosed herein. No single feature, function, element or property of the disclosed embodiments is essential to all embodiments. The following claims define certain combinations and subcombinations which are regarded as novel and non-obvious. Other combinations and subcombinations of features, functions, elements and/or properties may be claimed through amendment of the present claims or presentation of new claims in this or a related application. Such claims, whether they are different, broader, narrower or equal in scope to the original claims, are also regarded as included within the subject matter of applicants' invention.

We claim:

1. A method of printer-specific formatting of an application output, the method comprising steps of:
accessing an interrogator subroutine in a remote computer system from a server to poll the computer system for print information regarding an associated printer;
retrieving format information from a data structure corresponding to the polled print information; and
applying the format information to an application output to produce a printer-specific print job for printing on the associated printer.

2. The method of claim 1 which further comprises the step of communicating the printer-specific print job to the computer system for printing on the associated printer.

3. The method of claim 1, wherein the server accesses the interrogator subroutine via an Internet communications system.

4. The method of claim 1, wherein the print information identifies the printer model.

5. The method of claim 1, wherein the format information includes printer-specific printable area.

6. The method of claim 1, wherein the format information includes printer-specific minimum margins.

7. The method of claim 1, wherein the format information includes duplex printing capability.

8. The method of claim 1, wherein the format information includes color printing capability.

9. A server-side formatting system for formatting an output of a software application in accordance with format parameters corresponding to a printer of a remote computer system, the formatting system comprising:
a data structure configured to relate printers to format parameters associated with such printers; and
a format engine configured to access an interrogator subroutine of the remote computer system which identifies the printer of the remote computer system, to retrieve one or more format parameters corresponding to the identified printer from the data structure, and to apply the retrieved format parameters to the output of the software application so as to produce a printer-specific print job for printing on the printer.

10. The formatting system of claim 9, wherein the format engine is further configured to communicate the printer-specific print job to the computer system for printing on the identified printer.

11. The formatting system of claim 10, wherein the format engine communicates the printer-specific print job to the computer system via an Internet communications system.

12. The formatting system of claim 9, wherein the interrogator subroutine identifies the printer by printer model.

13. The formatting system of claim 9, wherein the format parameters include printable area of the printer.

14. The formatting system of claim 9, wherein the format parameters include minimum margins of the printer.

15. The formatting system of claim 14, wherein the minimum margins include a minimum top margin.

16. The formatting system of claim 14, wherein the minimum margins include a minimum bottom margin.

17. A printer-specific formatting system for formatting an output of a software application, the formatting system comprising:
a computer system having an interrogator subroutine and an associated printer with a printer identity, the interrogator subroutine being configured to communicate with the printer to identify the printer; and
a server system including a format engine and a data structure configured to relate printers to format parameters associated with such printers, the format engine being configured to access the interrogator subroutine to determine the printer identity, to retrieve format parameters corresponding to the printer identity from the data structure, and to apply such format parameters to the output of the software application to produce a printer-specific print job, the printer-specific print job being communicated to the computer system for printing on the identified printer.

18. The formatting system of claim 17, wherein the format engine communicates the printer-specific print job to the computer system via an Internet communications system.

19. The formatting system of claim 17, wherein the format engine accesses the interrogator subroutine via an Internet communications system.

20. The formatting system of claim 17, wherein the interrogator subroutine identifies the printer by printer model.
